(19) United States
(12) Patent Application Publication
(10) Pub. No.: US 2005/0005756 A1
(43) Pub. Date: Jan. 13, 2005

(54) Rotary cutting knife

(75) Inventors: Ronald Meisel, Kochel am See (DE); Jurgen Dichtl, Wolfratshausen (DE); Klaus Hogen, Kolbermoor (DE)

Correspondence Address: FITCH EVEN TABIN AND FLANNERY, 120 SOUTH LA SALLE STREET, SUITE 1600, CHICAGO, IL, 60603-3406, US

(73) Assignee: GAMMERLER AG

(21) Appl. No.: 10/888,247

(22) Filed: Jul. 9, 2004

(30) Foreign Application Priority Data
Jul. 10, 2003 (DE) 103 31 320.6

(51) Int. Cl. B26D 1/00

(52) U.S. Cl. 83/651; 83/663

(57) ABSTRACT

A rotary cutting knife for the cutting of print shop products is provided with a blade carrier at whose outer periphery blades are arranged such that only one cutting edge of the blades essentially projects over the outer periphery of the blade carrier. The blade carrier has cut-outs between two adjacent blades at its outer periphery.

The present invention relates to a rotary cutting knife for the cutting of print shop products comprising a blade carrier at whose outer periphery blades are arranged such that only one cutting edge of the blades essentially projects beyond the outer periphery of the blade carrier.

Such a cutting knife, which has proved itself very much in practice, is known from DE 37 19 721 C3. With this cutting knife, the individual blades dip into the cutting plane of the blade carrier such that a uniform cutting surface is formed. Since the blades are held displaceably in their cut-outs, the blades can be radially outwardly adjusted several times for the regrinding of the knife, whereupon surface grinding can take place in the cutting plane. No more readjustment of the individual blades is required after the grinding process.

A further advantage of this known rotary cutting knife lies in the fact that only one cutting edge of the blades essentially projects beyond the outer periphery of the blade carrier. In other words, the blades are secured in the blade carrier such that only their cutting edges essentially project beyond the outer periphery of the blade carrier, but not beyond these. This effects high running smoothness since the blades cannot oscillate during the cutting process due to their embedding in the blade carrier. Comparable advantages are achieved in an embodiment in which the blade carrier is a ring which is inserted into a substantially disk-shaped base body and to which the blades are connected in one piece.

The aforesaid rotary cutting knives have admittedly proven their value in numerous aspects in use, but the thickness of the print shop products to be cut with these knives is limited.

It is the object of the present invention to further develop a rotary cutting knife of the initially named kind such that print shop products having a relatively large thickness can be cut cleanly, for example product catalogues, telephone books and the like.

The aforesaid object is satisfied by the features of claim 1 and, with a rotary cutting knife of the initially named kind, in particular in that each blade has a convexly curved cutting edge and in that the blade carrier has a cut-out between two respective adjacent blades in each case at its outer periphery.

The rotary cutting knives in accordance with the invention can be arranged over one another in pairs such that the front sides of the two cutting knives lie inside a common cutting plane, with the blades of the one knife meshing with the blades of the other knife. Due to the cut-outs between two adjacent blades provided in accordance with the invention, the frontmost ends of the blades of the one knife can project into the cut-outs of the other knife. It is possible in this way to arrange both cutting knives extremely closely to one another or to allow the blades to overlap a lot, whereby a clean, smooth cut results overall, even when print shop products or an overlapping stream of print shop products having a comparatively large thickness are cut, for example, telephone books, mail-order catalogues or the like.

Since the rotary cutting knife in accordance with the invention has blades with convexly curved cutting edges, it is also ensured, when cutting thick print shop products, that the blades carry out a drawing cut at every time without a corner of the blades chipping into still uncut regions of the product.

The cut-outs provided between two adjacent blades at the outer periphery of the blade carrier can furthermore serve as a chip space to take up chips arising on the cutting of a printed product or to facilitate their formation.

Advantageous embodiments of the invention are described in the description, in the drawing and in the dependent claims.

In accordance with a first advantageous embodiment, the blade carrier can be a substantially conical base body, with elongate recesses being able to be provided on a curved conical surface of the blade carrier in which the blades are displaceably supported. The cut-out in this process can extend from the conical surface of the blade carrier up to a front surface of the blade carrier forming a cutting surface such that the cut-out completely passes through the blade carrier from its front side to its rear side. Such a cut-out can be manufactured relatively easily and ensures that the blades of the one knife can dip into the cut-outs of the other knife in a non-contact manner.

In accordance with a further advantageous embodiment of the invention, the blade carrier can be a ring which is inserted into a base body, in particular into a disk-like base body, and to which the blades are connected in one piece, with the cut-outs being formed at least at the ring between the blades. In this embodiment, the individual blades can admittedly not be released from the blade carrier, displaced and subsequently reground, but the same advantages with respect to the cutting quality result as with the first-described embodiment.

In accordance with a further advantageous embodiment of the invention, a web is provided at both sides of the cut-out and serves for the guidance and stabilization of the respective adjacent blade. It is hereby ensured that the blade is supported over as large an area as possible at its sides, whereby an unwanted oscillation of the blades is avoided.

A particularly advantageous cutting edge geometry results with two rotary cutting knifes meshing inside one cutting plane, when a part surface of each blade is arranged in a co-planar manner to the front surface of the blade carrier forming the cutting surface, with the blades being convexly curved on the sides opposite the part surface.

The securing of the blades in the blade carrier takes place in accordance with an advantageous embodiment such that at least a radial inner end of a cutting edge directly adjoins the blade carrier. It is ensured in this manner that the blades only project as far as absolutely necessary from the blade carrier. When the blades are arranged at an angle with respect to a radius, a second cutting edge of the blade can end slightly spaced apart from the outer periphery of the blade carrier.

In accordance with a further advantageous embodiment, the blades of the rotary cutting knife have two convexly curved cutting edges which merge into one another, in particular progressively. It is ensured, on the one hand, with this embodiment, that the blade has no sharp edges or corners in the region projecting beyond the outer periphery of the blade carrier which could chip into a product to be cut or which could leave unwanted cutting tracks in the region of an already cut product. On the other hand, such an embodiment can be produced in a particularly simple manner.

It is advantageous in this connection for the blade to be secured in the blade carrier such that the convexly curved cutting edge directly adjoins the blade carrier at its radially inner end, since a securing of the blade in the blade carrier which is the best possible and which prevents an oscillation of the blade is hereby given.

A blade is particularly suitable for the tooling of the rotary cutting knife in accordance with the invention which consists of an elongate base body with a rectangular cross-section, since the blade hereby finds a particularly good hold in the recess of the blade carrier formed in a complementary manner. The base body of the blade is provided at its front end with one or two cutting edges which are slightly convexly curved to achieve a uniform, drawing cut at any time. If the curved cutting edge ends at a planar side wall of the blade in this process, a particularly high stability and strength of the cutting blade is ensured. It can also be advantageous here to provide two curved cutting edges which are arranged symmetrically to a central axis of the blade, since the blades can hereby be inserted in two rotary senses.

In accordance with a further aspect, the invention relates to a cutting apparatus in which two similar rotary cutting blades of the type described above are driven synchronously and are arranged above one another such that the blades of one knife mesh between the blades of the other knife, with both knives being arranged with their front sides inside the same cutting plane and the front end of each blade of a cutting knife penetrating into the cut-outs of the other cutting knife. Comparatively thick overlapping streams or print shop products such as catalogues, telephone books and the like can also be cut perfectly with such an arrangement. Since the front end of each blade of a cutting knife penetrates into the cut-outs of the other cutting knife, a large overlap results between the two cutting knives, but the blades do not project far beyond the outer periphery of the blade carrier, but only by their cutting edges. A very stable cutting apparatus is provided with such an arrangement with which extremely thick print shop products can be cut very cleanly without unwanted vibrations occurring which would negatively influence the cut.

In accordance with an advantageous embodiment of the cutting apparatus in accordance with the invention, the two cutting knives can be arranged on shafts which are coupled by means of a belt or by means of a chain, on the one hand, and which each have a toothed wheel, on the other hand, with the two toothed wheels meshing with one another. With this embodiment, the synchronous drive of the two cutting knives takes place with the help of the belt, for example of a toothed belt, with the two toothed wheels meshing with one another, but not contacting one another in normal operation. If a tear or break occurs in the belt or in the drive chain due to an operational problem, the two toothed wheels engage into one another in a contacting manner such that a compulsory coupling of the cutting knives is ensured. A breakage of the blades can be avoided in this manner since a synchronous movement of the cutting knives is also ensured with a torn drive belt.

In accordance with a further embodiment, at least one of the two cutting knives can be supported axially displaceably in the cutting apparatus. It is hereby possible in a simple manner to ensure an exact alignment of the two cutting blades within one and the same cutting plane.

In accordance with a further advantageous embodiment, the cutting apparatus has a block-like housing, with a drive for the two cutting knives in particular also being secured to the housing. An extremely compact cutting module is provided by this embodiment which can carry out an edge trimming or a side trimming of an overlapping stream of print shop products. Such a cutting module can be arranged either in a cutting machine or also inside a cross-stacker, in the region of a conveyor path or at other positions of the overlapping stream coming from the printing machine.

In accordance with a further advantageous embodiment, the cutting apparatus can have a device for vertical adjustment. The cutting apparatus can hereby be adapted to print shop products of different thicknesses. It can likewise be advantageous for the housing of the cutting apparatus to be supported pivotably on a base element since the total cutting module can hereby be flipped out such that a simple assembly or servicing of the cutting knife is possible.

The present invention will be described in the following purely by way of example with reference to an advantageous embodiment and to the enclosed drawings.

There are shown:

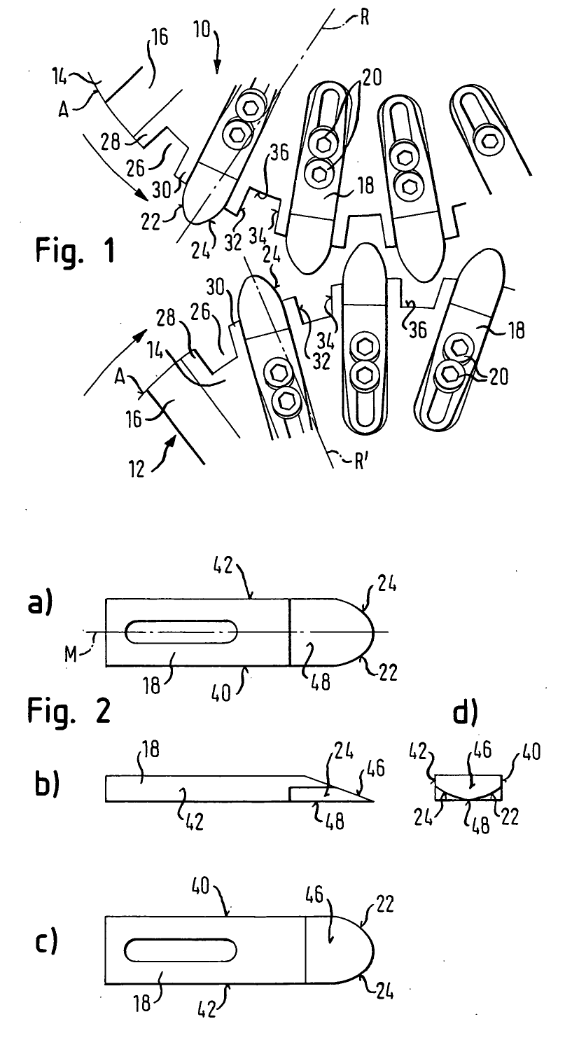

FIG. 1 a side view of a cutting apparatus having two meshing rotary cutting knives;

FIGS. 2a-d views of a blade for a cutting knife in accordance with FIG. 1; and

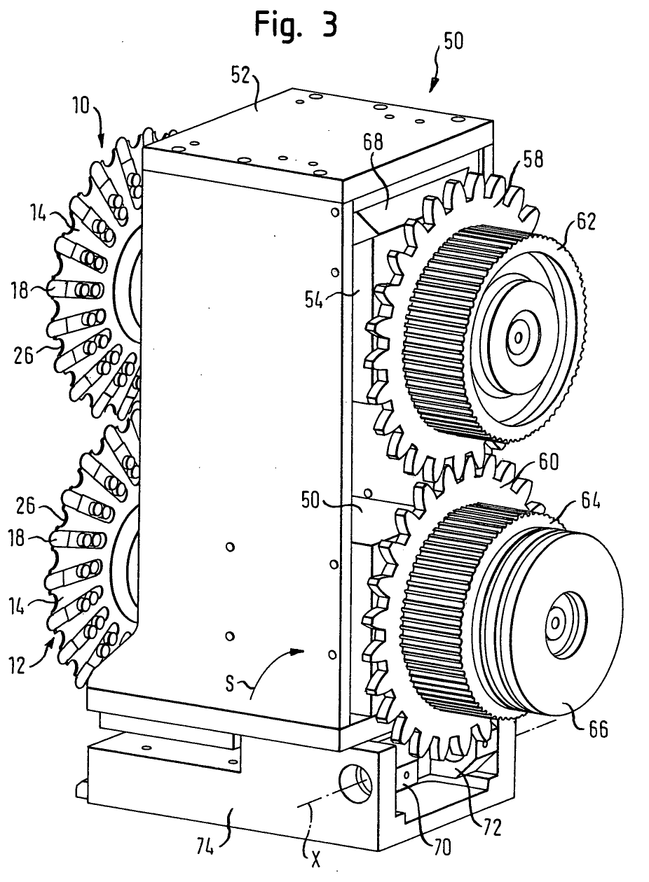

FIG. 3 a perspective view of a cutting apparatus having two meshing rotary cutting knives.

FIG. 1 shows the side view of a cutting apparatus having two rotary cutting knives 10 and 12 which are arranged over one another and in a meshing manner.

Each rotary cutting knife 10, 12 has a blade carrier 14 which is made as a substantially conical base body on whose curved conical surface elongate recesses 16 are provided in which one blade each 18 is displaceably supported and is secured with the help of two screws 20. Both the blades of the upper cutting knife 10 and the blades of the lower cutting knife 12 are arranged at an angle with respect to a radius ray R, R′ extended up to the front vertex of the blade. To this extent, the design of the rotary cutting knife in accordance with the invention corresponds to the cutting knives known from DE 37 19 721 A, with the disclosure content of this patent application also explicitly being made the subject of this application by reference. In contrast to the previously known blades previously described in this patent application, in accordance with the invention, each blade 18 has a convexly curved cutting edge 24 which directly adjoins the outer periphery of the blade carrier 14, with each blade essentially only projecting beyond the outer periphery of the blade carrier 14 with this cutting edge.

As FIGS. 1 and 2 show, the blades 18 are formed symmetrically to a symmetrical line or central axis M (FIG. 2a) such that each blade 18 has two convexly curved cutting edges 22 and 24 at their front ends which progressively merge into one another (in the mathematical sense). In other words, each blade 18 has no sharp edges or corners in their region projecting beyond the outer periphery of the blade carrier 14.

Approximately rectangular cut-outs 26 in the form of windows in the blade carrier are formed between two adjacent blades 18 at each blade carrier 14 and open in the radial direction toward the outer periphery A of the blade carrier 14. Each cut-out 26 is bounded in the peripheral direction by two webs 28 and 30 which are connected in one piece to the blade carrier 14 and which extend substantially parallel to the respectively adjacent blade 18. Each cut-out 26 is hereby bounded in the peripheral direction by two substantially radially extending web sections 32 and 34 which are connected to one another via a marginal section 36 substantially extending in the peripheral direction. Cut-outs 26 approximately quadrangular in plan view are hereby formed. It must, however, be pointed out that the transition between the web sections 32, 34 and the marginal section 36 can also be made rounded, which results in a simplified manufacture and in an improved chip removal.

The space formed by the cut-out 26 between the two web sections 32 and 34 can namely simultaneously serve as a chip space into which a chip can at least partly penetrate through the side at the outer periphery A of the blade carrier 14 open in the radial direction. The width of the chip space or of the cut-out 26 in this process substantially corresponds to the width of a blade 18 or of a recess 16.

The blades 18 for the cutting knives 10 and 12 shown in FIG. 1 are shown in more detail in FIGS. 2a-d. FIG. 2a here shows a plan view of the upper side of the blade 18 corresponding to FIG. 1. FIG. 2b shows a side view; FIG. 2c a plan view of the lower side and FIG. 2d a front view of the blade 18. The shape of the base body of the blade 18 of FIG. 2 differs from the blades shown in FIG. 1 to the extent that the blades shown in FIG. 1 are made in tapering fashion on their rear sides, which is not the case in the blade of FIG. 2.

As FIGS. 2a-d show, each blade 18 consists of a substantially rectangular base body with a flat, rectangular cross-section, with an elongate hole arranged at a central axis M being provided in the base body for the fixing of the blades by means of the screws 20.

At its front end, the blade 18 has the two slightly convexly curved cutting edges 22, 24 which both respectively end at their radially inner ends at a planar side wall 40, 42 of the blade. Both cutting edges 22 and 24 are arranged symmetrically to the central axis M of the blade 18. At the rear side of the blade which can be recognized in FIG. 2c, the two cutting edges 22 and 24 are bounded by a planar part surface 46 which extends in a co-planar manner to the front surface of the blade carrier forming the cutting surface in the installed state of the blade. As FIG. 2b shows, the part surface 46 extends at an angle to the longitudinal axis of the blade corresponding to the conical angle of the blade carrier 14. A further part surface 48 is provided at the side of the blade 18 lying opposite the part surface 46, is convexly curved in cross-section (cf. FIG. 2d) and extends from the one side surface 42 up to the other side surface 40. In the side view in accordance with FIG. 2b, however, the blade 18 has both a part of the planar side wall 42 and a part of the curved part surface 48 at its front end.

As FIG. 1 shows, the blades 18 are arranged in inclined manner with respect to a radius R, R′ of the blade carriers on the curved conical surface. At the same time, the blades 18 only project so far beyond the outer periphery A of the blade carrier 14 that the cutting edges 24 directly adjoin the blade carrier 14.

The two rotary cutting knives 10 and 12 shown in FIG. 1 are driven synchronously in the direction of the arrow in a cutting apparatus and are arranged above one another such that the planar front sides of the two rotary cutting knives both lie in the same cutting plane and such that the blades 18 of a knife mesh between the blades of the other knife. The mutual spacing of the two rotary cutting knives 10 and 12 is selected in this process such that the blades 18 of a knife dip into the cut-outs 26 of the other knife at their frontmost ends. The cut-outs 26 thus have a dual function in that, on the one hand, they form a chip space and, on the other hand, permit a low spacing apart and high overlap of the two rotary cutting knives.

The cutting apparatus shown in FIG. 1 cannot only be operated in the sense of rotation as is indicated by the two arrows. Operation is rather also possible in the reverse sense of rotation. It is only important that both knives rotate synchronously, with the rotational speed of the blades usually being larger than the speed at which the printed products are guided, for example in overlapping form, between the rotating rotary cutting knives.

Apart from the described embodiment, the most varied modifications of the rotary cutting knives in accordance with the invention or of the blades are possible. It is thus not necessary for the blades to be equipped with two cutting edges. The blades can also be connected in one piece to a ring-shaped blade carrier.

Extremely thick printed products, for example telephone books, mail-order catalogues or the like with a product thickness in the range of several centimeters, can be cut in a smooth, clean and drawing cut using the rotary cutting knives in accordance with the invention. An extremely clean cut is hereby created without unwanted markings in the cutting region.

FIG. 3 shows a perspective view of a cutting apparatus 50 having two rotary cutting knives 10, 12 which, as shown in FIG. 1, are arranged such that the blades 18 of the one knife 10 mesh between the blades 18 of the other knife 12, with the blades 18 of one knife 10 dipping at their front ends into the cut-outs 26 of the other knife 12. Both knives 10 and 12 have a common cutting plane and are supported in a block-like housing 52 which is made up of a total of four housing plates. Each cutting knife 10, 12 is supported at an end of a shaft which is arranged in a shaft bearing 54, 56 which is secured inside the housing 52. A respective toothed wheel 58, 60 is secured to the other end of each shaft, with the two toothed wheels 58 and 60 meshing with one another. A respective drive wheel 62, 64 is arranged subsequent to the toothed wheels 58 and 60 at the most extreme ends of the shafts such that the two shafts can be moved synchronously over a toothed belt (not shown). A drive wheel 66 is additionally provided at the free end of the lower shaft in FIG. 3 with whose help the two cutting knives are driven via a further drive belt by a drive motor (not shown). The drive motor is also fixedly connected to the housing 52 here.

As FIG. 3 shows, the shaft bearing 54 of the upper shaft is displaceably supported in the axial direction via a dovetail guide 68 such that the two cutting knives 10 and 12 can be aligned in a simple manner within one and the same cutting plane.

FIG. 3 further shows that the housing 52 of the cutting apparatus 50 is pivotally supported at a base part 74 via two swing supports 70, 72 such that the cutting apparatus 50 (in FIG. 3) can be tilted rearwardly in the direction S about the axis X to permit easy access to the cutting knifes 10 and 12. The base part 74 is secured to a device (not shown) for the vertical adjustment such that a vertical height adjustment of the cutting apparatus is also possible in a simple manner.

In normal operation, the drive of the two cutting blades 10 and 12 takes place via the drive motor (not shown) with the help of a drive belt which transmits the drive force to the drive wheel 66. Since the two shafts are driven synchronously to one another via the toothed belt (not shown) which connects the two drive wheels 62 and 64 to one another, the blades 18 of the two cutting knives 10 and 12 can mesh with one another in the manner shown in FIG. 1 and can engage into the cut-outs 26 of the respective other knife without any contact taking place between the two rotary cutting knives. The toothed wheels 58 and 60 arranged at the two knife shafts admittedly mesh with one another in normal operation, but the teeth of the two toothed wheels 58 and 60 do not contact one another. If, however, the toothed belt connecting the two drive wheels 62 and 64 should tear, a contact of the teeth of the toothed wheels 58 and 60, which only have low clearance, takes place such that the two rotary cutting knives 10 and 12 are still guided in a compulsory manner. Since the clearance between the teeth of the toothed wheels 58 and 60 is smaller in the peripheral direction than the clearance between the mutually meshing cutting knives 10 and 12, it is also ensured in the case of a belt tear that no contact of the two cutting knives 10 and 12 takes place such that a destruction of the blades is also precluded in this case.

The cutting apparatus shown in FIG. 3 represents an extremely compact and high-performance cutting module which can be used at the most varied positions in the region of the print post-processing. Since the axes of the two rotary cutting knives 10 and 12 coincide vertically, i.e. are arranged on a normal, a symmetrical design is present which can be easily integrated into existing plants.

### Reference Numeral List

10, 12 rotary cutting knives

14 blade carrier

16 recess

18 blade

20 screw

22, 24 cutting edge

26 cut-out

28, 30 web

32, 34 web sections

36 edge section

40, 42 planar side surface

46 planar part surface

48 convex part surface

50 cutting apparatus

52 housing

54, 56 shaft bearing

58, 60 toothed wheel

62, 64, 66 drive wheel

68 guide

70, 72 swing support

74 base part

A outer periphery

M central axis

S pivot direction

S pivot axis

1. A rotary cutting knife (10, 12) for the cutting of print shop products comprising a blade carrier (14) at whose outer periphery blades (18) are arranged such that only one cutting edge (24) of the blades (18) essentially projects beyond the outer periphery (A) of the blade carrier (14),
characterized in that
the cutting edge (24) of the blades (18) is convexly curved; and
in that a cut-out (26) is provided in each case between two adjacent blades (18) at the outer periphery (A) of the blade carrier.

2. A rotary cutting knife in accordance with claim 1, characterized in that the blade carrier (14) is a substantially conical base body and in that elongate recesses (16) are provided on a curved conical surface of the blade carrier (14), with the blades (18) being displaceably supported in these.

3. A rotary cutting knife in accordance with claim 1, characterized in that the blade carrier is a ring which is inserted into a base body and to which the blades are connected in one piece, with the cut-out being formed at least at the ring.

4. A rotary cutting knife in accordance with claim 2, characterized in that the cut-out (26) extends from the conical surface up to a front surface of the blade carrier (14) forming a cutting surface.

5. A rotary cutting knife in accordance with claim 1, characterized in that the cut-out (26) is a window in the blade carrier (14) open to the periphery of the blade carrier.

6. A rotary cutting knife in accordance with claim 1, characterized in that a web (28, 30) is provided at both sides of the cut-out (16) and serves for the guidance of an adjacent blade (18).

7. A rotary cutting knife in accordance with claim 1, characterized in that the blade (18) having a part surface (46) extends in co-planar manner to a front surface of the blade carrier (14) forming a cutting surface; and in that the blade (18) is convexly curved on the side (48) opposite the part surface (46).

8. A rotary cutting knife in accordance with claim 1, characterized in that the blades (18) are arranged in the blade carrier (14) such that a radially inner end of the cutting edge (24) is directly adjacent to the blade carrier (14).

9. A blade for a rotary cutting knife for the cutting of print shop products comprising a blade carrier (14) at whose outer periphery blades (18) are arranged such that only one cutting edge (24) of the blades (18) essentially projects beyond the outer periphery (A) of the blade carrier (14), the cutting edge (24) of the blades (18) being convexly curved, and a cut-out (26) being provided in each case between two adjacent blades (18) at the outer periphery (A) of the blade carrier, the blade consisting of an elongate base body having a rectangular cross-section, with the base body being provided at its front end with a cutting edge (22, 24) which is slightly convexly curved, with the curved cutting edge ending at a planar side wall (40, 42) of the blade.

10. A blade in accordance with claim 9, characterized in that two convexly curved cutting edges (22, 24) are arranged symmetrically to a central axis (M) of the blade (18).

11. A blade in accordance with claim 9, characterized in that two curved cutting edges (22, 24) are provided which progressively merge into one another.

12. A cutting apparatus (50) having two rotary cutting knives (10, 12) in accordance with claim 1 which have a common cutting plane, with the cutting knives (10, 12) being driven synchronously and arranged over one another such that the blades (18) of one knife (10) mesh between the blades (18) of the other knife (12, 10), with the blades (18) of one knife (10, 12) dipping at their front ends into the cut-outs (26) of the other knife (12, 10).

13. An apparatus in accordance with claim 12, characterized in that the two cutting knives (10, 12) are arranged on shafts which are coupled by means of a belt or of a chain, on the one hand, and which each have a toothed wheel (58, 60), on the other hand, with the two toothed wheels meshing with one another.

14. An apparatus in accordance with claim 12, characterized in that at least one of the two cutting knives (10) is supported in an axially displaceable manner.

15. An apparatus in accordance with claim 12, characterized in that it has a block-like housing (52), with a drive for the two cutting knives (10, 12) in particular also being secured to the housing (52).

16. An apparatus in accordance with claim 12, characterized in that it has a device for vertical adjustment.

17. An apparatus in accordance with claim 12, characterized in that it has a housing (52) pivotally supported on a base element (74).
